(19) United States
(12) Patent Application Publication
(10) Pub. No.: US 2013/0062281 A1
(43) Pub. Date: Mar. 14, 2013

(54) METHOD AND APPARATUS FOR TREATMENT OF WASTEWATER

(71) Applicant: William G. Smith, Southeastern, PA (US)

(72) Inventor: William G. Smith, Southeastern, PA (US)

(21) Appl. No.: 13/230,227

(22) Filed: Sep. 12, 2011

(51) Int. Cl. C02F 3/00

(52) U.S. Cl. 210/601

(57) ABSTRACT

Introducing a combination of high surface area growth media and biological reactants into a sewage treatment process with or without additional reaction to improve and increase capacity of a given process. The high surface area media and biological reactants can be dispersed at strategic locations in a new or existing attached growth wastewater treatment plant so as to provide additional sites for biological growth and improved wastewater renovation.

### BACKGROUND OF THE INVENTION

The present invention pertains to a method and apparatus for the treatment of wastewaters, more specifically, sanitary wastewaters, with a combination of materials, apparatus and equipment for both improvement of the treatment processes as well as the creation of additional treatment capacity. More particularly, the present invention pertains to a method and apparatus for retrofitting an attached growth system employing biofilms with high surface area materials as well as either intermittently or continuously feeding of selected biological and zeolitic material.

Over the past 20-30 years there has been an increase in the use of the Attached Growth systems in the wastewater treatment processes because of the inherently more efficient settling and often stable and higher treatment efficiency. Attached growth process are Trickling Filters, Rotating Biological Contactors, Denitrification filters including but not limited to conventional flow through rock or plastic media trickling filter modifications as well as submerged growth reactors.

Trickling filter reactors are large tanks filled with rock or plastic media upon which the wastewater is applied over the surface either continuously or intermittently and allowed to trickle down over the media. The filters have either passive or forced draft air ventilation system.

Wide variations in both the hydraulic and biological loading as well as temperature in attached growth sewage treatment process give rise to numerous operating problems as well as process inefficiency. Attached biofilm reactors become problematic when the wastewater volume or wastewater characteristics exceed the ranges designed for the systems. Any agent or combination of agents that can improve or expand the range of the operation band for attached growth type plants, will reduce the operating requirements as well as compliance excursions with effluent standards as well as being cost effective.

Zeolites have been successfully employed for improved wastewater treatment plant performance in accordance with the published literature and can provide a stabilizing effect during both long term and short term so fluctuations in sludge settleablilty and bacterial mass growth in sewage treatment plants are improved. It provides not only a weighting agent for increasing the sludge settling characteristics but also a platform for bacterial growth which performs a function similar to that of an attached growth media systems.

The use of zeolitic materials on various support media for sewage treatment has been documented. The prior art search specifically for zeolite attached to these materials has been documented by the following patents:

| Patent | Pat. No. | Filing Date | Issue Date |
|---|---|---|---|
| Stuth | 7,552,766 | February 2005 | Aug. 7, 2007 |
| Horing | 6,855,255 | January 2003 | Feb. 15, 2005 |
| DeFilippie | 6,395,522 | January 1994 | May 22, 2002 |
| Heitkamp | 5,980,738 | October 1996 | Nov. 9, 1999 |
| Sanyal | 5,217,616 | December 1991 | Jun. 8, 1993 |
| Lupton | 4,983,299 | April 1989 | Jan. 8, 1991 |

The above referenced patents employ a method of attachment of the zeolite or other materials to the support material. These all employ a packed bed reactor through which the wastewater is forced. Another example of prior art are the following patents:

| Patent | Pat. No. | Filing Date | Issue Date |
|---|---|---|---|
| Smith | 7,452,468 | September 2006 | November 2008 |
| Smith | 7,507,342 | February 2007 | March 2009 |

These patents are based on the dosing of either or the zeolite and bacteria into a trickling filter or rotating biological contactor wastewater treatment plant which employs some form of media. In these patents materials are separate and unsupported dosed materials applied to trickling filter or rotating biological wastewater treatment processes.

### SUMMARY OF THE INVENTION

The present invention is a method for improving the treatment of wastewater, e.g. sanitary wastewater in an attached growth biofilm wastewater process such as trickling filters, rotating biological contactors or fixed bed reactor, employing rock or plastic media either stationary or rotating through the wastewater by the addition of zeolitic or high surface area materials as a dosed material which is added to the wastewater as it is applied to the reactor. The term “hybrid trickling filter” has been employed to describe a conventional trickling filter or rotating biological contactor that employs both conventional media and the dosed high surface area media. The term “hybrid rotating biological contactor” has been employed to describe a conventional rotating biological contactor that employs both conventional media and the dosed high surface area media.

The addition of biological agents have improved the performance of trickling filter/attached biofilm processes, both aerobic and anoxic, for the removal of carbonaceous as well as nitrogenous materials.

Incorporation of a combination of zeolitic materials and biological agents in trickling filter, rotating biological contactor or other attached growth reactors will improve the overall efficiency of the process.

The zeolitic material and biological agents can be dispersed into an attached growth reactor or the bioreactors of a conventional flow through process by the dosage of the zeolitic material with or without the bacterial component into the applied wastewater stream to the reactors.

Therefore, in one aspect the present invention is a method for improving a wastewater treating process employing one of trickling filter process or a rotating biological contactor process comprising the steps of: introducing into one or more of the bioreactor tanks of a biofilm treatment process a quantity of zeolitic biological material growth media being one of clinoptilolite, mordenite, chabazite or phillipsite, and one or more biological agents to effect one or more of an increased production of extra cellular polysaccharide for better liquid solid separation; removal of ammonia-nitrification, denitrification, removal of carbonaceous material, reduce surfactant interference with liquid solid separation, provide a balanced nutrient formulation in the wastewater, phosphate removal and odor removal.

### BRIEF DESCRIPTION OF THE DRAWINGS

The present invention will hereinafter be described in conjunction with the appended drawing figures wherein like numerals denote like elements.

FIG. 1 is a plot of the zeolite dose against effluent COD. As the dosage is increased so is the amount of surface area and therefore the decrease in the amount of COD remaining.

FIG. 2 is a plot of the zeolite dose against equivalent media surface area present in the reactor as a result of the amount of zeolite added.

FIG. 3 is a plot of the zeolite dose against effluent TKN. Total Kjeldahl Nitrogen or TKN is the sum of organic nitrogen, ammonia (NH3), and ammonium (NH4+) in the chemical analysis of soil, water, or wastewater (e.g. sewage treatment plant effluent). To calculate Total Nitrogen (TN), the concentrations of nitrate-N and nitrite-N are determined and added to TKN.

FIG. 4 is a schematic representation of points of application of zeolite in several configurations of a Trickling Filter Plant

### DETAILED DESCRIPTION OF THE INVENTION

The following detailed description provides preferred exemplary embodiments only, and is not intended to limit the scope, applicability, or configuration of the invention. Rather, the ensuing detailed description of the preferred exemplary embodiments will provide those skilled in the art with an enabling description for implementing the preferred exemplary embodiments of the invention. It being understood that various changes may be made in the function and arrangement of elements without departing from the spirit and scope of the invention, as set forth in the appended claims.

The following equation is normally employed for estimating the removal of nitrogen by a trickling filter. The nitrification rate units are lb−N/ft̂2/day. This equation therefore is dependent upon the surface area of the tricking filter for the media employed in the trickling filter. The smaller the carbon to nitrogen ratio the higher is the nitrification rate. This is due to the preferential oxidation of the carbon before the nitrogen. This equation does not specifically employ any recirculation rate considerations but can take into it into consideration if it is included in the Carbon & Nitrogen loading onto the trickling filter. This equation is empirically based on the ratio of the applied Carbon loading to Total Kjeldahl Nitrogen loading onto the trickling filter using empirically developed correction coefficients

$$NitriRate = 0.82 \cdot {[ \frac{Si}{RawTKN} ]}^{( - 0.44 )} \qquad Equation 1$$

Using the data below and solving Equation 1, one arrives at a nitrification rate of 0.00012 lb−N/ft̂2/day.

All of the data reported in Tables 1-7 was generated by mathematical model.

TABLE 1

| Status | Input | Name | Output | Unit | Comment |
|---|---|---|---|---|---|
| | | NitriRate | 0.00012 | Lb-N/ft\hat{ }2/day | Nitrification |
| | | | | | Rate Oakley |
| | | | | | Albertson |
| | | | | | Nitrification |
| | | | | | Rate |
| | | Si | 207 | mg/l | COD Loading |
| | | | | | onto Filter |
| | 86 | RawNH3 | | mg/l | Influent NH3 |
| | | | | | concentration |
| | 0.85 | TKNfactor | | | Ratio factor |
| | | | | | of NH2 |
| | | | | | to TKN |

Equation 2 can be employed to compute the value of the applied TKN if the ratio of the TKN to Ammonia (NH3) is known. The value of 0.85 shown in Table 1 is a commonly employed value for domestic wastewater.

$$RawTKN = \frac{RawNH 3}{TKNfactor} \qquad Equation 2$$

Equation #3 is the standard equation employing the total fixed media surface area, a factor and the Nitrification to determine the mass of ammonia (NH3) removed by a trickling filter with a given amount of surface area based on the media employed in the filter.

NH3removed_Std=(\acute{O}FixedArea·0.0283·NitriRate) Equation 3

Two parallel trickling filters with the total surface area of 27,695 square feet of rock media having a specific surface area of 15 square feet of surface area per cubic foot of media were loaded at 12,000 gallons per day with the loadings shown in Table 1. Table 2 shows the trickling filter specifics for this installation. The filters were preceded by an equalization basin and a single primary clarifier. The value of Si used in the loading equation was after assigning a 35% COD removal efficiency for the primary clarifier and a filter recycle rate of 400%.

TABLE 2

| Status | Input | Name | Output | Unit | Comment |
|---|---|---|---|---|---|
| | | FilterArea | 307.72 | ft\hat{ }2 | Estimated Hickory Run |
| | | | | | Filter Area |
| | | ΣFilterVol | 1,846 | ft\hat{ }3 | Total Filters Volume |
| | | ΣFixed Area | 27,695 | ft\hat{ }2 | Total Filters Surface Area |
| | | | | | Fixed Media |
| | | FixMediaSurfaceArea | 15 | ft\hat{ }s/ft\hat{ }3 | Media Type Surface Area |

Employing Equation 3 the mass of NH3 predicted to be removed is 10.3 lb per day as is shown in Table 3.

TABLE 3

| Status | Input | Name | Output | Unit | Comment |
|---|---|---|---|---|---|
| | | NH3removed_Std | 10.3 | lb/day | TKN removal |
| | | | | | based on |
| | | | | | conventional |
| | | | | | Media Surface |
| | | | | | Area |

Table 4 below shows a model for the same trickling filter plant to which has been added 5 pounds per day of a zeolitic material according to the present invention. The zeolite has a specific surface area of 29,500 square feet per pound. It has been reported in the literature that 98% of zeolite is removed from a trickling filter plant. This includes removal in both the primary and final clarifiers as well as any material enmeshed in the biofilm on the trickling filter. In the trickling filter plant being discussed the zeolite was dosed to an aerated recirculation sump after the two primary trickling filters which then recirculate back to the influent to the two rock trickling filters. Field data indicated that 3.3% of the dosed zeolite surface area was effective in increasing the total surface area in the trickling filters.

Table 4 indicates that an additional 4,868 square feet of surface area is being added daily to the trickling filter media by the addition of the zeolite.

TABLE 4

| Status | Input | Name | Output | Unit | Comment |
|---|---|---|---|---|---|
| L | 5 | ZeroMassDose | | lb/day | Dosage of zeolite |
| | | ZeoliteConc | 50 | mg/l | Zeolite Concentration |
| | | | | | Dosage based on flow |
| | 29,500 | | | ft\hat{ }2/lb | Surface Area of Zeolite |
| | 0.033 | ZeoliteEffective | | Decimal | Zeolite Effective Area |
| | | | | | factor |
| | | ΣZeoliteAreaAdded | 147,500 | ft\hat{ }2/day | Total Zeolite Surface Area |
| | | | | | Added |
| | | DailyZeoliteArea | 4,868 | ft\hat{ }2 | Effective Surface Area |
| | | | | | added daily |
| | | ΣZeoliteBiofilm | 97,350 | ft\hat{ }2 | Total Zeolite Area |
| | | | | | @Biofilm Age |

In trickling filter plants just as in Activated Sludge wastewater plants there is an age to the bacteria. In Activated Sludge it is determined by sludge wasting whereas in a trickling filter plant it is controlled by the biofilm growth and resulting sloughing of the biofilm off the media. Using the numbers shown in the model and a sloughing rate of 5% one has a 20 day biofilm age and a 97,350 square feet of additional surface area due to the zeolite. This results in a total effective surface area of the 27,695 square feet due to the rock media plus the 97,350 square feet due to the zeolite (3.3% effective area for the zeolite as explained previously) for a 352% increase in total surface area. The net effect of this is that it has the same effect as removing the rock media and replacing it with plastic media having a specific surface area of 67.73 square feet per cubic foot without and the of the capital costs.

Table 5 indicates that the volumetric loading rates, a measure of carbonaceous material materials, are dramatically improved as well.

TABLE 5

| Status | Input | Name | Output | Unit | Comment |
|---|---|---|---|---|---|
| | | | | | ====> Conventional |
| | | | | | Trickling Filter Design |
| | | | | | Calculations <==== |
| | | Si | 207 | mg/l | COD Loading onto Filter |
| | 12,000 | Q | | gpd | Raw Sewage Flow |
| | 675 | So | | mg/l | Primary Effluent COD |
| | | | | | (can use BOD) |
| | 4 | a | | | Ratio of Return Flow to |
| | | | | | Raw Flow |
| | 90 | Se | | mg/l | Trickling Filter Effluent |
| | | | | | COD |
| | 0.39 | K1 | | min\hat{ }−1 | Organic removal velocity |
| | | | | | constant @ T1 |
| | 1.04 | Theta | | | Temperature coefficient |
| | | | | | (1.1 to 1.35) |
| | 18 | T2 | | | Water Temperature Actual |
| | | | | | Deg. C |
| | 20 | T1 | | | Water Temperature Ideal |
| | | | | | 20 Deg. C |
| | | Av | 15 | sqft/cuft | Specific Surface of Media |
| | 6 | D | | ft | Media Depth |
| | | q | 0.54 | gpm/sqft | Hydraulic loading onto |
| | | | | | filter - media only |
| | | n | 2.71 | | Visilind ‘n’ after Vicarri |
| | | | | | 2007 |
| | 14 | d | | ft | Diameter of Filter |
| | | Qr | 48,000 | gpd | Recirculation Flow |
| | | Er | 86.67 | % | COD Removal Efficiency |
| | 2 | Filter# | | | Number of Filters |
| | | FilterArea | 307.72 | ft\hat{ }2 | Estimated Hickory Run |
| | | | | | Filter Area |
| | | ΣFilterVol | 1,846 | ft\hat{ }3 | Total Filters Volume |
| | | ΣFixedArea | 27,695 | ft\hat{ }2 | Total Filters Surface Area |
| | | | | | Fixed Media |
| | | FixedMediaSurfaceArea | 15 | ft\hat{ }2/ft\hat{ }3 | Media Type Surface Area |
| | | FixedMediaLoadingRate | 36.59 | lb | Conventional Loading |
| | | | | COD/1000 Ft\hat{ }3 | Rates for Roc (5 to 20 lb/ |
| | | | | | 1000 ft\hat{ }3) |
| | | Vlr | 73.14 | lb/1000 ft\hat{ }3 | Organic Volume Loading |
| | | | | | (w/recirc.) lb/1000 cuft |
| | | Vl | 112.15 | lb/1000 ft\hat{ }3 | Organic Volume Loading |
| | | | | | (w/recirc.) lb/1000 cuft |
| | | HydLoading | 39 | gpd/ft\hat{ }2 | Fixed Media Hydraulic |
| | | | | | Loading Rate |
| | | CODload | 67.55 | lb | Estimated Plant COD |
| | | | | COD/day | Loading |
| | | HydClass | “Low | | Hydraulic Filter Loading |
| | | | Rate | | Class based on physical |
| | | | | | filter volume |
| | | OrgLoadClass | “High | | Organic Filter Loading |
| | | | Rate | | Class based on physical |
| | | | | | filter volume |
| | | | | | ====> Zeolite |
| | | | | | Calculations <==== |
| L | 5 | ZeoMassDose | | lb/day | Dosage of zeolite |
| | | ZeoliteConc | 50 | mg/l | Zeolite Concentration |
| | | | | | Dosage based on flow |
| | 29,500 | ZeoliteArea | | ft\hat{ }2/lb | Surface Area of Zeolite |
| | 0.033 | ZeoliteEffective | | Decimal | Zeolite Effective Area |
| | | | | | factor |
| | | ΣZeoliteAreaAdded | 147,500 | ft\hat{ }2/day | Total Zeolite Surface Area |
| | | | | | Added |
| | | DailyZeoliteArea | 4,868 | ft\hat{ }2 | Effective Surface Area |
| | | | | | added daily |
| | | BiofilmVolume | 577 | ft\hat{ }3 | Biofilm Volume on Fixed |
| | | | | | Media |
| | 0.25 | BiofilmThickness | | inch | Biofilm Thickness |
| | | BiofilmMass | 5,2983 | lb | Biofilm Mass |
| | | BiofilmAge | 20 | days | Equivalent Fixed Media |
| | | | | | Age based on sloughing |
| | 0.05 | BiofilmSoughingRate | | % | Media Sloughing Rate % |
| | | ΣZeoliteBiofilm | 97,350 | ft\hat{ }2 | Total Zeolite Area @ |
| | | | | | Biofilm Age |
| | | SurfaceAreaIncrease | 352 | % | Surface Area Increase % |
| | | | | | using Biofilm Age Σ area |
| | | Vlhybrid | 12.43 | lb/1000 ft\hat{ }3 | Volume Loading |
| | | | | | (w/recirc.) lb/1000 cuft |
| | | Vlryhbrid | 2.49 | lb/1000 ft\hat{ }3 | Volume Loading |
| | | | | | (w/recirc.) lb/1000 cuft |
| | | ΣCombinedArea | 125,045 | ft\hat{ }2 | Total Effective Surface |
| | | | | | Area in Filters |
| | | EqTotalVol | 8,336 | ft\hat{ }3 | Equivalent Filter Volume |
| | | | | | for both Media |
| | | HybridLoadingRate | 0.54 | lb | Organic Loading Rate for |
| | | | | COD/1000 ft\hat{ }3 | Hybrid |
| | | Sehybrid | 0 | mg/l | Effluent COD hybrid |
| L | | Avhybrid | 67.73 | ft\hat{ }2/ft\hat{ }3 | Equivalent Surface Area |
| | | | | | based on filter volume |
| | | Qhybrid | 0.005 | gpm/sqft | Hybrid loading onto Σ |
| | | | | | filter surface area |

NH3removed=(\acute{O}CombinedArea·0.0283·NitriRate) Equation 4

Table 6 shows the mathematical model calculated nitrification rate base on the data shown in Table 5 and as calculated by Equation 1 and shown in Table 1.

TABLE 6

| Status | Input | Name | Output | Unit | Comment |
|---|---|---|---|---|---|
| | | NitriRate | 0.00012 | lb- | Nitrification Rate |
| | | | | N/ft\hat{ }2/day | Oakley Albertson |
| | | | | | Nitrification Rate |

Equation 4 is similar to Equation 3 with the only difference being total effective surface area. The Nitrification Rate as determined by Equation #1 can be employed in both Equation #3 and Equation #4. Now if one had a mathematical model for the trickling filter plant and empirical field data for both the influent and effluent Ammonia then though invertible iterative solving of the mathematical model one could arrive at the Nitrification Rate that was actually taking place in the plant under actual operation condition. Employing actual field data from the full scale hybrid trickling filter plant employing the zeolite and a Nitrification Rate increase of 0.00012 lb−N/ft̂2/day as shown in Table #6 the effective surface area of the added zeolite was determined to be 3.3%. Therefore the use of the zeolite has added additional surface area which in turn via both plant performance and mathematical modeling validates the increase in surface area created by the dosing of zeolite to a fixed media wastewater treatment process and the resulting improved trickling filter performance. The increase in ammonia removal was 40% based field data which confirms the increase in surface area. The effect of the zeolite is not solely a surface area phenomenon. The model has assumed that the nitrification rate stayed a fixed value. In reality the improvement is due to both an increase in surface area and an increase in biological processes for both carbonaceous and nitrogenous materials.

Table 7 is shows in input and output data from the mathematical model based on the field data. It should be noted that the “NitriRate” variable shown in Table 7 is the same as that shown in Table 6 and Table 1.

TABLE 7

| Status | Input | Name | Output | Unit | Comment |
|---|---|---|---|---|---|
| | | | | | ====> Primary Filter |
| | | | | | Nitrification Calculations |
| | | | | | <==== |
| | | NitriRate | 0.00012 | lb- | Nitrification Rate Oakley |
| | | | | N/ft\hat{ }2/day | Albertson Nitrification |
| | | | | | Rate |
| | | RawTKN | 101.18 | mg/l | Raw TKN applied to |
| | | | | | trickling filter |
| | 86 | RawNH3 | | mg/l | Influent NH3 |
| | | | | | concentration |
| | 0.85 | TKNfactor | | | Ratio factor of NH3 to |
| | | | | | TKN |
| | | RawTKNmass | 10.13 | lb/day | Raw TKN Loading on |
| | | | | | Filter |
| | | NH3removed | 4.66 | lb/day | TKN removal based on |
| | | | | | combined Media Surface |
| | | | | | Area |
| | | NH3removed_Std | 10.03 | lb/day | TKN removal based on |
| | | | | | conventional Media |
| | | | | | Surface Area |
| | | TKNeffmasshydridel | 5.45 | lb/day | TKN left with hybrid |
| | | | | | surface media |
| | | TKNeffmassstd | 9.09 | lb/day | TKN left with standard |
| | | | | | surface media |
| | | EffTKNstd | 90.84 | mg/l | Effluent TKN with |
| | | | | | standard media |
| | | EffTKNhybrid | 54.51 | mg/l | Effluent TKN with hybrid |
| | | | | | media |
| | | NH3RemovalEff % | 40% | % | Hybrid Filter NH3 |
| | | | | | removal increase |

The data shown below in Table 8 is actual field data that has been measured in the field and employed in the mathematical models to evaluate the performance of the hybrid trickling filter.

TABLE 8

| Plant Flow | Influent EQ | Influent | EQ Basin | Eff Batch | Eff Batch |
|---|---|---|---|---|---|
| gpd | NH3—N | TKN | COD | NH3—N | NO3—N |
| 51,328 | 38.4 | | 419 | 0.153 | 1.640 |
| 30,000 | 31.2 | | 376 | 0.144 | 0.930 |
| 32,400 | 30.6 | | 620 | 0.0159 | 0.898 |
| 31,700 | 32.6 | | 526 | 0.064 | 0.921 |
| 35,500 | 38.4 | | 709 | 0.026 | 1.020 |
| 30,598 | 29.8 | | 536 | 0.012 | 1.350 |
| 36,782 | 35.8 | | 461 | 0.053 | 1.330 |
| 52,300 | 33.4 | | 442 | 0.174 | 1.550 |
| 37,515 | 33.4 | | 338 | 0.002 | 1.170 |
| 38,289 | 32.4 | | 350 | 0.041 | 0.954 |
| 41,012 | 26.0 | | 463 | 0.040 | 1.420 |
| 35,700 | 35.8 | | 775 | 0.013 | 1.830 |
| 22,097 | 31.0 | | 438 | 0.020 | 2.300 |
| 45,597 | 35.4 | | 244 | 0.442 | 1.910 |
| 59,081 | 26.6 | | | 1.340 | 1.930 |

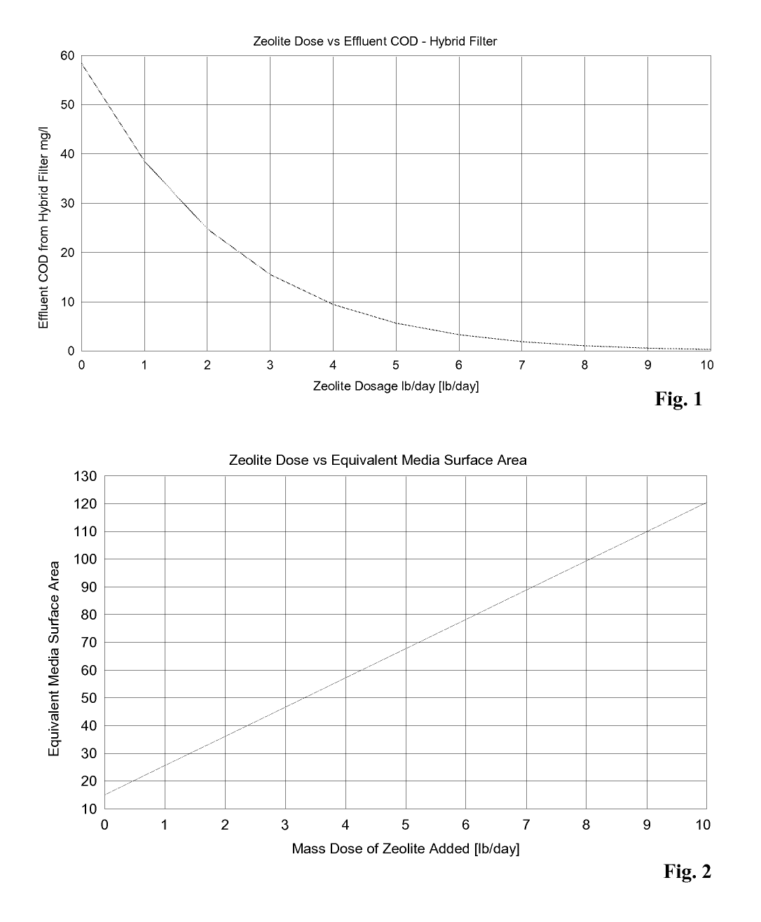

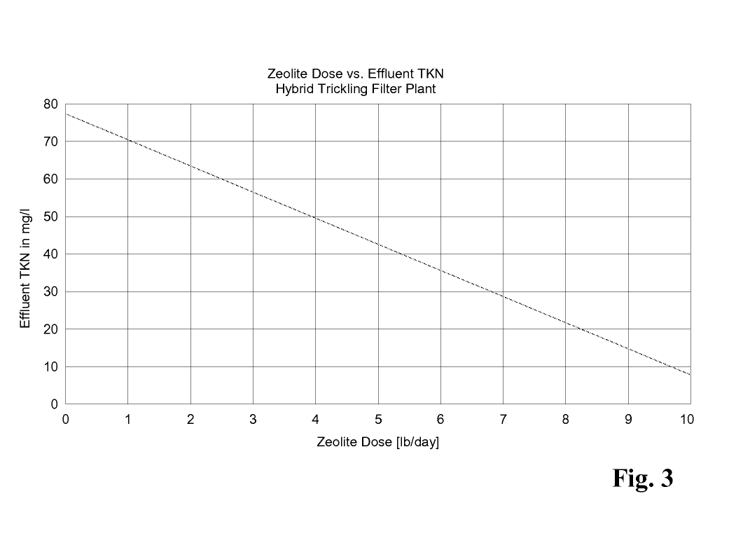

The plotted data shown in FIG. 1, FIG. 2, and FIG. 3 illustrate a significant and dramatic impact of the addition of the zeolite to a fixed film media reactor, either Trickling Filter or Rotating Biological Contactor with more effective surface area.

An evaluation of the field data since the use of the zeolite addition has produced the following evaluation of the actual rock trickling filter performance vs. the model predictions employing standard design equations for nitrification performance. This evaluation again shows that there has been a dramatic increase in the surface area in the trickling filter.

TABLE 9
Mathematical Model vs. Field Data Comparison
Trickling Filter Performance - Mathematical Model vs.
Field Data (Standard Filter vs. Hybrid Filter)

| Name | Value | Unit | Comment |
|---|---|---|---|
| EffTKNstd | 90.84 | mg/l | Model Prediction Effluent |
| | | | TKN with standard media |
| EffTKNhybrid | 50.21 | mg/l | Model Prediction Effluent |
| | | | TKN with hybrid media |
| Field Raw NH3 | 71.98 | mg/l | Measure Average Applied |
| | | | NH3 |
| Model Raw NH3 | 81.40 | mg/l | Model Applied NH3 |
| Field TF Eff NH3 | 29.58 | mg/l | Measure Average Hybrid |
| | | | Filter Eff NH3 |
| EffNH3std | 72.80 | mg/l | Model Prediction Effluent |
| | | | NH3 with standard media |
| EffNH3hybrid | 51.40 | mg/l | Model Prediction Effluent |
| | | | NH3 with hybrid media |
| % NH3 Std Model | 10.6% | % | Projected % Removal by |
| | | | Model Standard Trickling |
| | | | Filter |
| % NH3 Field | 28.59% | % | Actual % Removal by Hybrid |
| | | | Trickling Filter |
| & NH3 Std Model | −1.14% | % | Predicted % Removal by |
| | | | Model for Std Trickling Filter |
| Model vs Field | −73.7% | % | Correlation between Model |
| | | | vs. Field for Hybrid |

| | |
|---|---|
| Effective Surface Area | 2.30 Zeolite Effective Area factor |
| Nitrification Rate Model | 0.00012 lb-N/ft\hat{ }2/day |
| Equivalent Surface Area | 51.75 ft\hat{ }2/ft\hat{ }3 Equivalent Surface Area |
| | based on filter volume |
| Nitrification Rate Field | 0.00027 lb-N/ft\hat{ }2/day |
| Data | |
| Equivalent Surface Area | 93,577 ft\hat{ }2/ft\hat{ }3 Equivalent Surface Area |
| Field Data | based on filter volume |

TABLE 10
Field Performance Evaluation

| | | Primary Filter | Primary filter | Actual lb | | |
|---|---|---|---|---|---|---|
| | Primary filter | Nitrification | Nitrification | NH3 | Equivalent | % Increase |
| | % NH3 | Rate lb | Rate Field | Removed lb | Surface | in Surface |
| | Removed | N/day-Sq-Ft | Data | N/day-Sq-Ft | Area ft\hat{ }2 | Area |
| Average | 44.18% | 0.00007 | 0.00027 | 7.83 | 98,452 | 355% |
| Maximum | 85.33% | 0.00013 | 0.00074 | 15.74 | 160,791 | 581% |
| Minimum | 3.85% | 0.00004 | −0.00005 | 1.79 | 34,549 | 125% |
| Std. Dev | 21.08% | 0.00002 | 0.00020 | 3.63 | 43,297 | 156% |

Both Table 9 and Table 10 indicate that for the trickling filter to be performing as measured by actual field data indicates that a large increase in viable surface area in the trickling filter has been achieved by the addition of the zeolitic material. According to Table #10 it would appear that the nitrification rate has decreased. These values were in fact back calculated from the field data. The “Primary Filter Nitrification Rate” value was determined using Equation 1 whereas the “Primary Filter Nitrification Rate Field Data” employed the amount of nitrogen removed based on the surface area of the rock media. Therefore in order for the Trickling Filter to be removing the amount of nitrogen that was measured in the field there had to be an increase in the surface area and thus the values indicated in the “Equivalent Surface Area” as shown in Table 10.

A particular Trickling Filter plant was experiencing wide variations in applied hydraulic and organic loadings due to seasonal activities e.g. weekend vs. weekday flows. Superimposed on top of these varying loads was the fact that it was for a rest stop facility on a major Turnpike with its related variations in flows due to varying use of the rest stop as well as wastewater characteristics. In addition, the rest stop generated wastewater that was high in ammonia and Chemical Oxygen Demand due to the use of low water use toilets with winter temperatures of the wastewater in the 4 to 5° C. (39.2 to 41.0° F.) range. The regulatory agency was taking actions due to the facility not meeting its NPDES permit requirements even after being retrofitted with an addition plastic media trickling filter complete with covers for the trickling filter and hot air ventilating/heating system.

The raw waste exhibited ammonia nitrogen levels in the range of 50 to 135+mg/l with Chemical Oxygen Demand (COD) levels as high as 900+mg/l as well as temperatures of 4 Degrees C. Adjustment of the recirculation rates, sludge wasting and normal process adjustments for a trickling filter plant to address the reduction of these values was met with limited success. In addition, due to the wide swings in wastewater characteristics, swings in biofilm sloughing were incurred with the resulting decrease in the settleablilty of the sludge and subsequent loss process control. The plant also had problems meeting its ammonia requirements for a large portion of the year round.

A Trickling Filter treatment plant comprised of an equalization tank, primary clarifier, two parallel rock trickling filters, a secondary plastic media trickling filter followed by a final clarifier and a disinfection system with the plant having a design capacity of 40,000 gallons per day. The Trickling Filter was out of compliance due to excessively high concentrations of COD and BOD, ammonia-nitrogen, low conversion of ammonia nitrogen, poor settling, low BOD5 removal and low temperatures.

In a first part of the process of the present invention, Zeolite, obtained from Daleco Resources Corporation of West Chester, Pa., were employed at a dosage of 50 parts per million based on the average daily flow to the plant. It should be noted that the Trickling Filter process is preceded by both an Equalization Basin and Primary Clarifiers and has an internal recycle from the effluent from the Trickling Filter. The dosage is based on the raw sewage flow to the plant. Therefore each train of the Trickling Filter process was having 25 parts per million of zeolite being applied to it.

The zeolitic material addition operated as a weighting agent, substrate and structural unit with large surface area per unit volume for bacterial growth to occur as well as an ion exchange site for ammonia. In wastewater treatment it is the culturing of assimilated bacteria to the wastewater composition that affects the treatment process performance. Employing a zeolitic material allowed more bacteria to grow and stay in the process longer to affect the treatment process performance, stability and operability. The design of Trickling Filters and attached growth treatment processes are based on the organic (BOD) loading rate per unit of surface area. The surface area is defined by the square feet of surface created by the specific media employed e.g. rock has 15 square feet per cubic foot of media volume while synthetic plastic media can be as much as 32 square feet per cubic foot of media volume. The amount of zeolite employed is based on the desired increase in surface area required in order to achieve the desired loading rates for either or both carbon and nitrogen based pollutants.

In order for the zeolites to reach an effective level in the waste treatment process an optimum dose must be reached; in this case 30 to 60 parts per million, based on the daily flow to the plant. Additionally, since the bacteria must grow and create a culture on the zeolites material the zeolites effectiveness is directly related to the Retention Time in the treatment system. For a Trickling Filter or attached growth system the equivalent Retention Time would be based on the amount of sloughing that occurs of the biofilm that is attached to the media. In this instance a value of 5% was employed for the amount of biofilm sloughing that was taking place. The other consideration is the amount of zeolite that would be entrapped in the biofilm. It has been reported in the literature that 95% of a zeolite applied to a Trickling Filter plant is removed. This value was the basis for employing 5% as the amount of zeolite entrapped in the biofilm. In this application the daily flow of 6,000 gallons per day would be ((6,000*8.34*60)/1,000,000) or 3.0 pounds per day. The biofilm age (based on the sloughing rate) was 20 days and each reactor was receiving 3,000 gallons per day, each reactor would be receiving 1.5 pounds of material. On the first day 0.075 pounds of the zeolite would be retained in the biofilm. On day two there would be another 0.075 pounds of zeolite retained in the biofilm with a sloughing loss of 5%. After the first day 5% of the first day's 0.075 pounds of zeolite would be wasted. On the second day 5% of the 0.07125 pounds would be wasted along with 5% of the second day's 0.075 pounds. After two days there would be 0.139 pounds of zeolite enmeshed in the biofilm. At the end of 20 days there would be 1.425 pounds of zeolite in the biofilm on each trickling filter.

If the average surface area for zeolites is 700 square meters per gram, (29,500 square feet per pound) then in the 20 day biofilm age example there would be 1.425 pounds of zeolites in the biofilm at a 5% biofilm enmeshment rate The effective growth area for bacterial growth that one would have is 2,213 square feet of surface area per day per trickling filter or at a biofilm age of 20 days over 44,250 square feet of surface area. The combined primary filters have a total surface area of 27,695 square feet using 15 square feet per cubic foot for the rock media. This amounts to a 159% increase in surface area if all the added zeolitic material was effective or a total surface area of 71,945 square feet. Actual field data at the plant indicated that the effective surface area of the added zeolite is 3.3% effective when the actual effective surface area is computed based on the performance of the rock filters. The higher the biofilm age the greater square feet of added effective surface area retained in the filter. This effectively increases the rock media from 15 to 47 square feet per cubic foot of surface area for each Trickling Filter. This has effectively increased the rock trickling filter to a plastic media trickling filter without the cost of retrofit. The effectiveness of increasing surface area for bacterial growth in wastewater treatment via numerous methods is well documented in the literature. Taking the amount of zeolitic material up to the steady state concentration has been employed; however, it still takes a number of biofilm ages for the zeolitic material in the reactor to develop the bacterial colonization. The 3.3% effective surface area takes into consideration sloughing loss and effective surface area for colonization.

Using removal rates for BOD5 for the zeolitic material is equivalent to changing the media in the filter based on the additional media with a 3.0% effective surface area for the total amount of zeolitic material that is in the system at a steady state the BOD5 removal could be improved from approximately 30% to 80%+ as shown in the data.

The cost effectiveness of the implementation of the use of this method of improving an attached growth e.g. trickling filter or rotating biological contactor plant employing different types of media including rock and plastic media would be the cost of the zeolite additive. Assuming an installed cost to replace the rock media in a 20,000 gallon per day trickling filter plant with high surface plastic media of $300 per cubic foot installed then the capital savings for the demonstration plant are $553,800 minus the ongoing going cost of the zeolite For this plant they are using 5 pounds per day. The cost for the zeolite is approximately $2.50 per day or $912 per year to get this performance enhancement vs. a cost of $553,800.

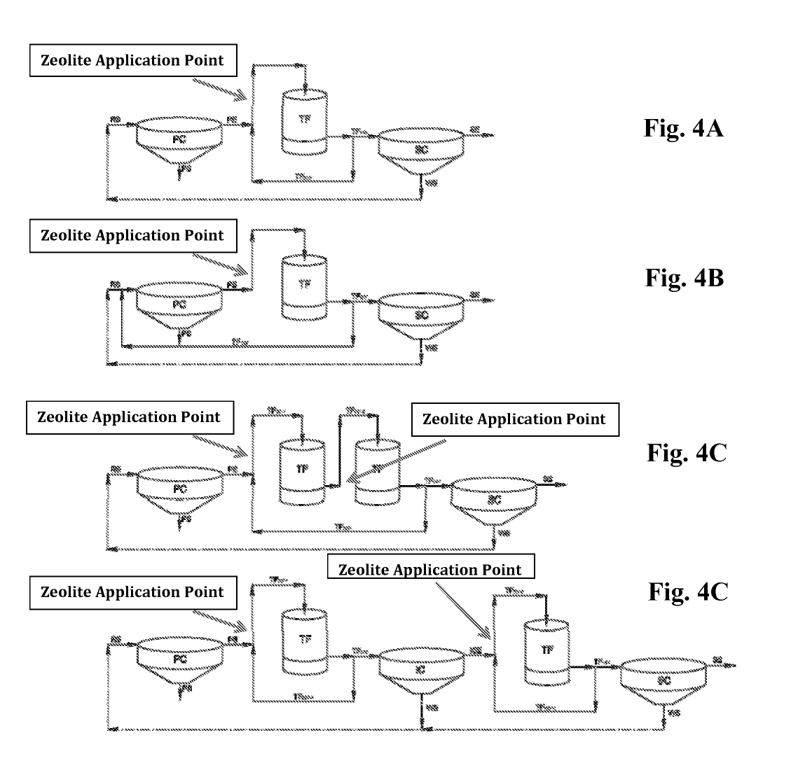

As show in FIG. 4A through FIG. 4D, the processes of the present invention can be applied at numerous locations in a trickling filter plant. As used in FIG. 4A through FIG. 4D the following abbreviations are used to describe the different pieces of equipment used in atypical trickling filter plant:
Legend: (RS)—raw wastewater, (PC) primary clarifier, (PE) primary effluent, (TF_{INF}) trickling filter influent, (TF) trickling filter, (TF_{EFF}) trickling filter effluent, (TF_{RCY}) trickling filter recycle, (SC) secondary clarifier, (WS) waster sludge, (SE) secondary effluent, (IC) intermediate clarifier, (ICE)

In place of a trickling filter, a sewage treatment process may employ rotating biological contactors. In that case the additions are also made to the wastewater stream.

The foregoing detailed description provides illustrative embodiments only, and is not intended to limit the scope, applicability, or configuration of the invention. Referring to the detailed description of the preferred exemplary embodiments will provide those skilled in the art with an enabling description for implementing the invention.

Having thus described my invention what is desired to be secured by letters patent of the United States is set forth in the appended claims.

1. A method for improving a wastewater treating process employing one of a trickling filter or rotating biological contactor comprising the steps of introducing into the wastewater stream which is applied to said trickling filter or rotating biological contactor of the wastewater treatment process one or more of a quantity of separate and unsupported natural zeolitic material being one of clinoptilolite, mordenite, chabazite or phillipsite and/or one or more cultured bacterial agents to effect one or more of an increase production of extra cellular polysaccharides for better liquid solid separation, or removal of ammonia, denitrification, COD and BOD removal, reduction of surfactant interference with liquid solid separation, provide a balanced nutrient formulation in the wastewater.

2. A method according to claim 1 including the step of introducing one or more of the zeolitic material and/or cultured bacterial agent onto the trickling filter media of the wastewater treating process.

3. A method according to claim 1 including the step introducing the zeolitic material and/or cultured bacterial agent into one of a conduit or wastewater conveyance leading directly to the trickling filter reactor.

4. A method according to claim 1 including the step of introducing one or more of the zeolite material and/or cultured bacterial agent into a recirculation system of the trickling filter reactor.

5. A method according to claim 1 including the step of introducing zeolite material and/or cultured bacterial agent in the recirculation system for a rotating biological contactor.

6. A method according to claim 1 including the step of introducing zeolitic material onto a channel or pipe leading directly to the trickling filter reactor.

7. A method according to claim 1 including the step introducing zeolitic material into a recirculation system for the trickling filter reactor.

8. A method according to claim 1 including the step of introducing one of the zeolite material and/or cultured bacterial agent onto the rotating biological contactor media.

9. A method according to claim 1 including the step introducing one of the zeolitic material and/or cultured bacterial agent into a channel or pipe leading directly into the rotating biological contactor.

10. A method according to claim 1 including the step of introducing one of the zeolitic material and/or cultured bacteria agent into a recirculation system for the rotating biological contactor.

11. A method according to claim 1 including the step of introducing the zeolitic material onto the rotating biological contactor media.

12. A method according to claim 1 including the step of introducing the zeolitic material into a channel or pipe leading directly to the rotating biological contactor.

13. A method according to claim 1 including the step of placing the zeolite material in the recirculation system for the rotating biological contactor.

14. A method according to claim 1 including the step of selecting the natural zeolitic material from the group consisting of clinoptilolite, mordenite, chabazite, phillipsite and mixtures thereof.

15. A method according to claim 1 including the step of mixing the zeolitic material with alumina, silica, hydroxide, hydroxide precursors, and calcium oxide with a silica to alumina ration equal to or greater than 2.5.

16. A method according to claim 1 including the step of selecting the cultured bacterial agent from the group consisting of an agent to increase production of extra cellular polysaccharide for better liquid solid separation, an agent for removal of ammonia, an agent to promote denitrification, an agent to reduce surfactant interference with liquid/solid separation, an agent to provide a balanced nutrient formulation in the wastewater, an agent to promote phosphate removal, an agent to promote odor removal and mixtures thereof, and an agent for the removal of BOD and COD.
